(19) United States
(12) Patent Application Publication
(10) Pub. No.: US 2009/0067311 A1
(43) Pub. Date: Mar. 12, 2009

(54) METHOD AND APPARATUS FOR RECORDING SECONDARY INFORMATION ON A RECORD CARRIER

(75) Inventors: Peter Bentvelsen, Eindhoven (NL); Ludovicus Marinus Gerardus Maria Tolhuizen, Eindhoven (NL); Willem Marie Julia Marcel Coene, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,409

(22) PCT Filed: Nov. 4, 2005
(86) PCT No.: PCT/IB2005/053601

§ 371 Date: May 2, 2007

(30) Foreign Application Priority Data
Nov. 9, 2004 (EP) 04105641.7

(51) Int. Cl. G11B 7/00; G11B 7/24

(52) U.S. Cl. 369/100; 369/275.4

(57) ABSTRACT

The present invention relates to a method of recording secondary information on a record carrier, in particular on an optical record carrier, besides its content information, whereby it is possible to differentiate the record carrier from other record carrier bearing the same content information, for example by recording an individual identifier. The secondary information is recorded by: forming at predetermined positions dummy patterns (23), preferably at the same moment as when recording the content information, and recording the secondary information by selectively modifying the dummy patterns, thereby obtaining modified dummy patterns (24), wherein the dummy patterns as well as the modified dummy patterns correspond to valid channel words. The invention further relates to an apparatus for recording secondary information, to a record carrier, and to a method and to an apparatus for reproducing the secondary information.

The present invention relates to a method and to an apparatus for recording secondary information on a record carrier.

The present invention relates further to a record carrier onto which record secondary information and to a record carrier having recorded secondary information.

Still further, the present invention relates to a method and an apparatus for reproducing secondary information recorded on a record carrier.

It is known that ROM optical discs are obtained by a molding process, whereby a plurality of discs having exact replicas of the same content information, or user data, is obtained, the content information being e.g. music, a movie, software, which is often a copy-protected material. For some application it would be desirable that the individual discs would differ at least in some part of the carried information. However this cannot be achieved by said molding process. A straightforward application could be, for example, the possibility to distinguish individual discs as a basis for an authentication, access control, or copy protection scheme, particularly in the context of super distribution.

In WO 02/101733 a so-called post-recording method is described which makes it possible to record a secondary information, such as a Unique Disc ID, onto a read-only optical record carrier after disc production. The method, also called “Postscribed ID” (PID), is also used by Sony for CD-ROM. In PID, lands between the stamped pits can be converted, so as to give a pit-like reflection, using laser ablation. The thin film reflective layer (that usually consists of aluminum for conventional discs) has a special composition to allow ablation of the layer. After ablation, the local reflectance will be low and comparable to a stamped pit. Recording in a pit will not lead to a significant reflectivity change, thus, overwritten pit sections remain ‘pit’ whereas overwritten ‘land’ sections are transformed into ‘pit’ for the read-out process. Using this method it is thus possible to adapt the modulation stream, therefore, a plurality of CD-ROM having the same user-information can be obtained in a first step by a molding process; in a second step, the individual members of the plurality can be differentiated by adding an individual Postscribed ID (a Unique Disc ID; in general, a secondary information) to each disc. In order not to corrupt the content information, a special area of the disc is provided where dummy patterns, not relevant for the user and not part of the content information, are pre-recorded: the secondary information is added here.

It is an object of the present invention to provide a method and an apparatus for recording secondary information on a record carrier by which the secondary information can be reproduced in a relatively simple way.

It is a further object of the present invention to provide a record carrier onto which the secondary information can be recorded or has been recorded, which secondary information can be reproduced in a relatively simple way.

It is a yet further object of the present invention to provide a method and an apparatus for reproducing secondary information recorded on a record carrier which are relatively simple.

The object is achieved according to the present invention by a method as claimed in claim 1 and by an apparatus as claimed in claim 11 or 12. The further object is achieved by a record carrier as claimed in claim 17 and 18. The yet further object is achieved by method as claimed in claim 20 and by an apparatus as claimed in claim 21. Advantageous embodiments are defined in the dependent claims.

It has to be noted that the secondary information is recorded in the same information channel where the content information is pre-recorded, and thus needs to be retrieved by use of substantially the same demodulation/decoding circuitry.

It also has to be noted that the content information is present in the information carrier in the form of a modulated bitstream obtained from the content information by encoding the content information and modulating the encoded content information. Encoding the content information comprises a combination of:

an error correction code (ECC) generation, by which the data words representing the content information are enhanced with ECC,

shuffling the data words and/or interleaving them with other data words, and

scrambling the data words.

Modulating the encoded content information foresees converting each data word into a channel word, representable as a pattern of 1s and 0s, or, in case of an optical record carrier, pits and lands.

The invention is primarily based on the recognition that both in providing an area for being modified in a post-recording process, as well as in having this area modified in the post-recording process, it is potentially introduced on the record carrier some pattern which is not compliant with modulation rules that are foreseen.

The reasons for the presence of a modulation step can be to introduce some redundancy which allows to detect/correct errors while retrieving the recorded content information, and/or to render the information to be recorded in a form which is compatible with the bandwidth constraints imposed by a particular recording system, like for example in Optical Storage where a Run-Length Limited (RLL) encoding is used. In Optical recording systems, like for example according to CD, DVD or BD standards in particular, the modulation step comprises a step of associating to a data word of n bits a channel word of m bits, with m>n. As a consequence, ill the space of channel words, i.e. all the 2^{m} channel words obtainable with m bits, only some are foreseen by the relevant modulation algorithm (EFM for CD, EFM+ for DVD and 17PP for BD), whereas the other are non-valid channel words. In contrast, the channel words to which a data word can be associated are herein referred to as valid channel words. In a reproduction apparatus the detection of a non-valid channel word gives rise to marking that channel word as erroneous during demodulation.

According to the invention, the dummy patterns predisposed for being modified in a post-recording process, as well as the dummy patterns modified, are compliant with the modulation rules employed, i.e. they need to be valid patterns, or corresponding to valid channel words, otherwise, as non-valid patterns, they would oblige to an adaptation of the demodulation. Moreover, as non-valid patterns, the dummy patterns could violate the RLL (read: bandwidth) constraints of the channel, putting even more burden on the analog pre-processing of the High Frequency signal retrieved from the record carrier and on the demodulation in general in order to correctly detect these patterns.

Instead, with the dummy patterns being valid patterns, no modifications at demodulation level and analog pre-processing are necessary at all; the upper layer—the decoding level—instead, has to be adapted, because it has to know where the dummy patterns are supposed to be, and how they are supposed to look like, with or without modification. During decoding there must not be an attempt to correct the patterns that have been modified in the post-recording process. However this adaptation is a relatively simple one. In practice, the dummy patterns are placed at predetermined locations; a unit in a decoder will check one by one if the patterns present at the predetermined locations have been modified or not, thereby retrieving the secondary information which has been recorded.

Thus, according to the present invention, in order to allow the recording, or “post-recording” as is sometimes referred, of a secondary information, which can be individual to each record carrier, such as a Unique Disc ID, dummy patterns which are valid patterns are formed at predetermined location. The secondary information can then be stored on the record carrier by selectively modifying said dummy patterns in said post-recording process.

It is clarified that, in the context of this document, the expressions “dummy pattern” and “dummy channel word” are not used to refer a pattern or a channel word of no value at all, but rather a pattern or a channel word which is not carrying any content information. I.e., the dummy pattern or dummy channel word are indeed irrelevant, or “dummy”, from the point of view of the content information, nevertheless the are relevant to the secondary information, since a dummy pattern or channel word, whether modified or not stores a piece of said secondary information. The distinction between pattern and channel word is clarified hereinafter.

In the case of a ROM record carrier, i.e. a record carrier where the content information is pre-recorded and is not modifiable by the user, the dummy patterns and the patterns encoding the content information are preferably formed by means of a unique step, for example a molding process. Therefore it is possible to create a plurality of record carriers having prerecorded the same content information, where differentiated secondary information can then be recorded. However the invention can also be applied to record carriers recordable by the user, where the method according to the invention can be used to pre-record an individual code on the record carrier, which can be useful according to some models of distribution of copy-protected content.

In an embodiment the modifying of the dummy patterns is obtained according to a modification mask which extends over the patterns to be modified. A modified dummy pattern is obtained as the result of the logical operation OR between the dummy pattern and the modification mask, the dummy pattern being represented by the value 1 in correspondence to a pit and 0 elsewhere, the modification mask being represented by the value 1 in correspondence to a point to be modified and 0 elsewhere. This reflects a modification of the dummy patterns which is effected by laser ablation, whereby pits remain pits and that lands are modified into pits. Preferably the record carrier comprises a thin film reflective layer including a material composition allowing ablation of said layer by use of radiation, in particular laser light. Of course, other known or future methods for post-recording of information on an optical record carrier may be used in combination with the invention. In this case it is possible to characterize as follows a dummy pattern and a modification mask to be used in the method according to the invention: the result of the logical operation OR between the dummy pattern and the modification mask must also be a pattern corresponding to a valid channel word.

It has to be said that it is in general not known a priori with which polarity a given channel word appears as pattern in the modulated bitstream, which is a non return to zero modulated bitstream. In fact according to 17PP modulation, similarly to EFM and EFM+, it is foreseen that:

first, a channel word, i.e. a string of bits, is associated to a data word,

then, a pattern of pits and land is constructed upon the string of bits according to the following rule: a transition from pit to land or vice versa for a 1, no transition for a 0, the initial level, pit or land, being defined according to the previous word.

Therefore a given channel word may be represented with a given pattern or its opposite. It has to be reminded that with the known post-recording method it is only possible to convert ‘lands’ into ‘pits’. Since with the known post-recording method it is only possible to convert ‘lands’ into ‘pits’, it follows that it is necessary to control the polarity of the generated modulated bitstream. This need for a control of the polarity in the modulation bitstream can be dispensed with in an embodiment of the method of the invention, according to which regardless of the polarity with which a channel word appears in the modulated bitstream, a modification is applied which modifies the dummy pattern into another pattern corresponding to a valid channel word. That is, the modification mask and the dummy pattern have the further property that the pattern obtainable as the result of the logical operation OR between the negative of the dummy pattern and the modification mask is also a pattern corresponding to a valid channel word. Obviously this restricts the possible choice of dummy patterns and modification masks. In this case it is correct to talk about dummy channel word.

As it has already been said, the channel words are recorded on the record carrier as patterns of pits and lands. These patterns have a finite length of n length units, corresponding to a channel bit or clock cycle, the pits and the lands extending over one or more length units. While modifying a dummy pattern care has to be taken that the modification takes place exactly where specified according to the modification mask. If the modification is obtained by laser ablation while scanning a track present on the record carrier, a strain is put on the synchronization of the switching on and off of the laser. In an embodiment of the method of the invention the dummy pattern and the modification mask have the property that the pattern obtainable as the result of the logical operation OR between the dummy pattern and the modification mask, where the beginning and/or end of a post-recording mark defined by the modification mask is shifted of one length unit, is also a pattern corresponding to a valid channel word.

As it has already been said, the method according to the invention can be used in conjunction with EFM, EFM+ or 17PP. According to EFM and EFM+, the data words are individually converted into channel words. According to 17PP instead, the conversion of a data word into a channel word (and vice-versa), depend in general also on the previous and next data word (channel word) in the sequence of encoded data words (channel words). Therefore, when applying the invention in conjunction with 17PP, preferably the dummy patterns are chosen so as to have the characteristic that during demodulation the dummy patterns as well as the dummy patterns modified are converted into respective data words regardless of the content of the previous and following channel words.

The invention will now be explained in more detail with reference to the drawings in which:

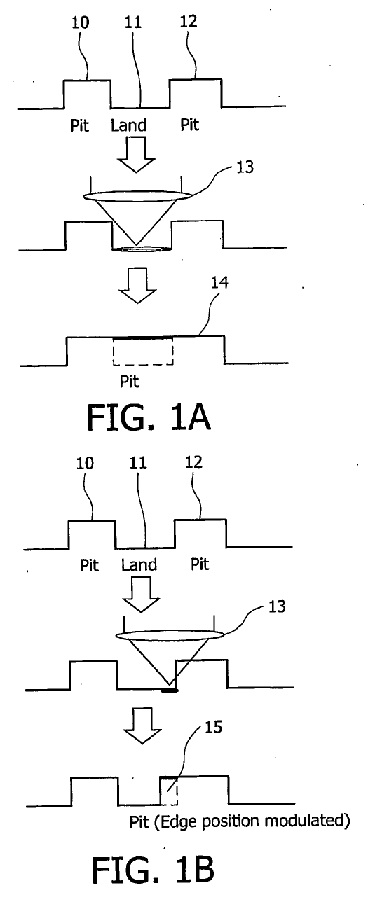

FIGS. 1a and 1b illustrate the basic principle of a known post-recording method,

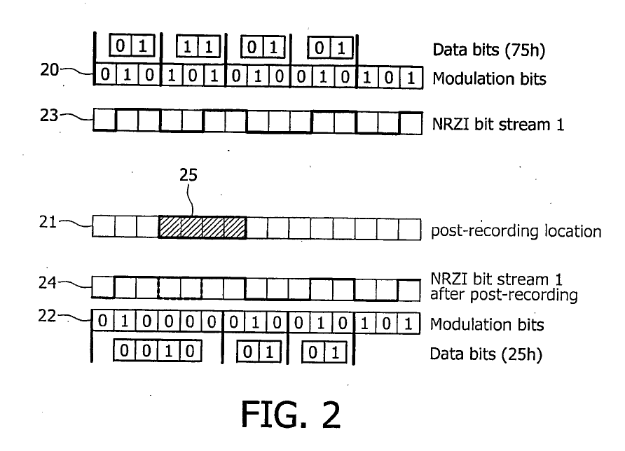

FIG. 2 shows a dummy pattern and modification masks for use in the method according to the invention,

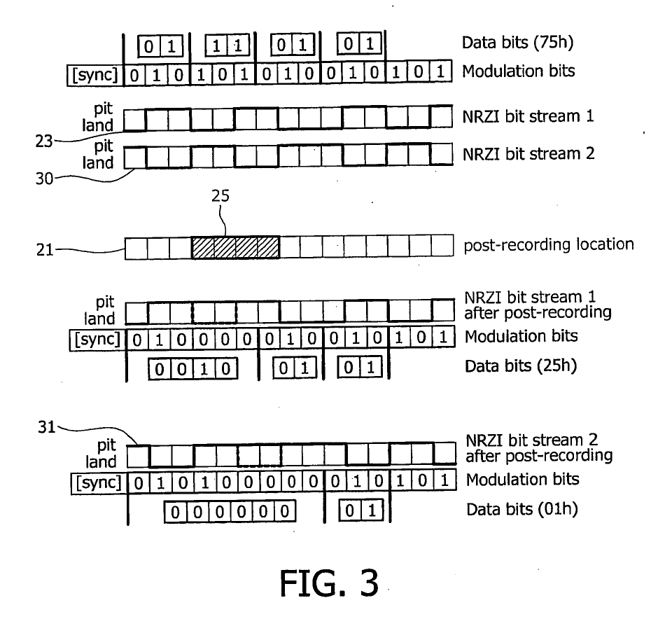

FIGS. 3 to 5 show various embodiments of dummy channel words and modification masks for use in the method according to the invention,

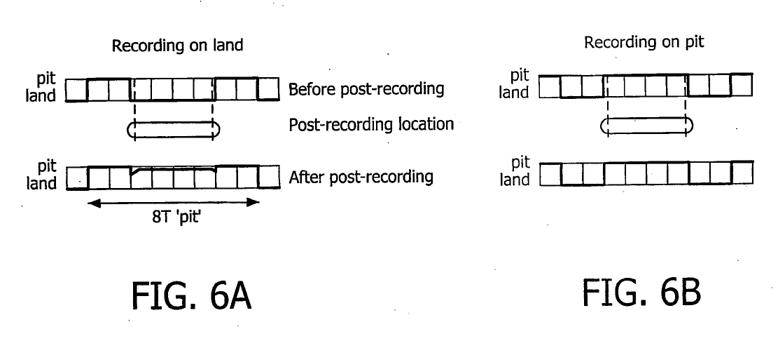

FIG. 6 illustrates the effect of post-recording on a land and on a pit area in an embodiment of the method according to the invention,

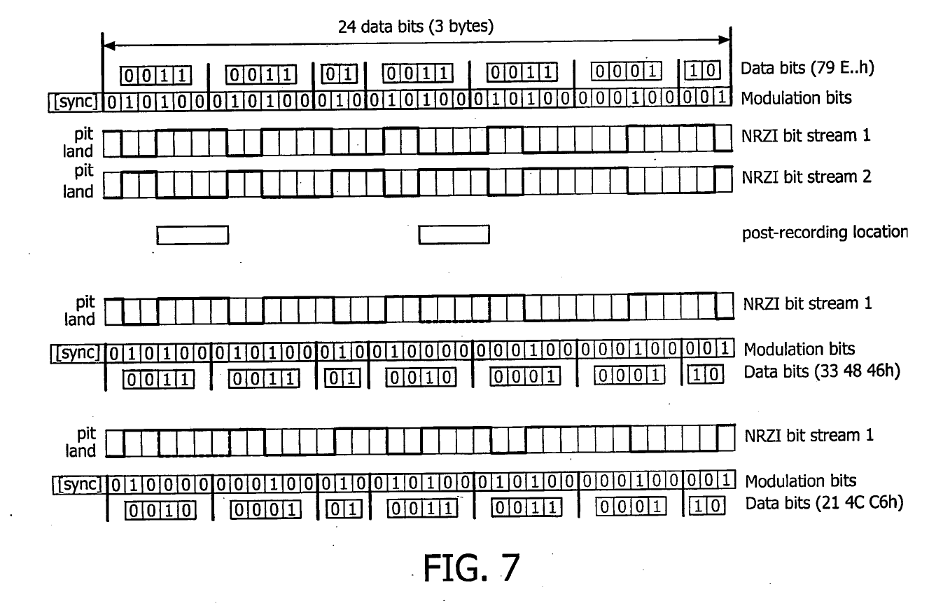

FIGS. 7 to 10b show further embodiments of the method according to the invention,

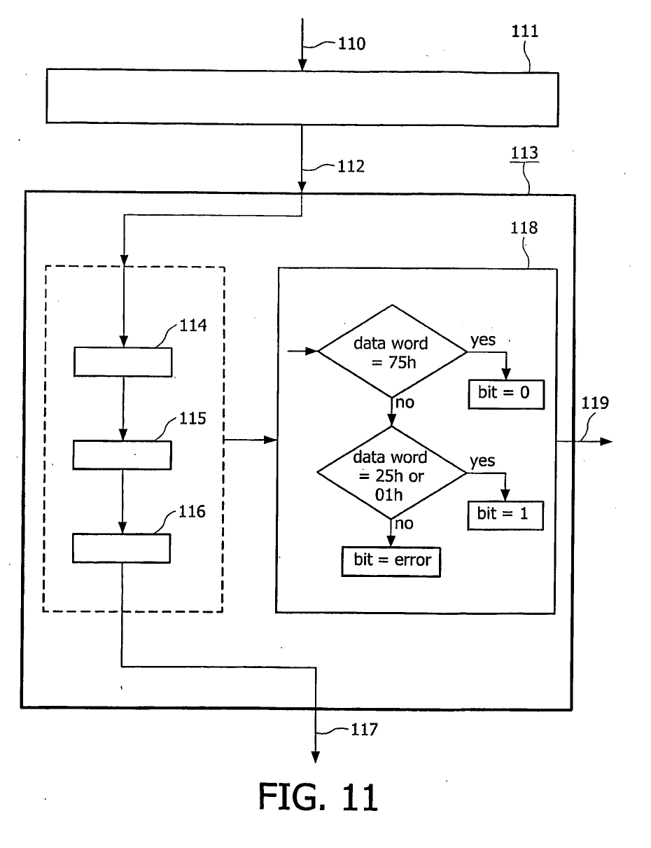

FIG. 11 schematically illustrates an apparatus for reproducing the secondary information according to the invention.

FIG. 1 illustrates the basic principle of a post-recording process, as for instance known from WO 02/101733. FIG. 1A shows how a land portion 11 located between two pit portions 10 and 12 is modified by the application of a high power laser radiation 13 which, in the known method, causes laser ablation and a reflectivity change so that the reflectivity of the previous land portion 11 is low and comparable to the reflectivity of the neighboring (stamped) pit portions 10 and 12. The sequence pit-land-pit thus results in a long pit area 14.

While in the examples shown in FIG. 1A the whole land area 11 is irradiated by said laser radiation 13, in the example shown in FIG. 1B only part of the land area 11 close to the right-hand pit portion 12 is irradiated by said laser radiation 13 causing only said part of the land portion 11 to be modified into a pit portion. The result is that the edge position 15 of the right-hand pit is modulated, i.e. the run-length of said pit has become longer. The pattern which results from this post-recording process can be expressed as the result of the logical operation OR between the pre-existing, or pre-recorded, pattern of pits and lands and a modification mask, which modification mask defines where acts the laser radiation over the pre-existing pattern, where for the pre-existing pattern 1 indicates pit and 0 indicates land, and for the modification mask 1 indicates radiation acting and 0 indicates no radiation acting.

According to the invention both the pre-existing or pre-recorded pattern and the pattern as it is modified with the post-recording process actually correspond to valid channel words. Clearly a channel word is a valid channel word or not in reference to a given modulation algorithm. For example, according to EFM, which is used for CD a channel word consists of 14 channel bits, and a bi-univocal relation is defined between data words, consisting of 8 bits, and channel words. This means that only 2⁸ channel words are valid channel words, out of 2¹⁴ channel words obtainable as with all combinations of 14 bits. The need for a modulation step, where channel words are associated to data words, which clearly introduces some redundancy, has already been explained above.

In the following, reference is made to 17PP modulation, which use is foreseen according to the BD standard. Although the invention is going to be explained with reference to BD, this must be understood simply as an example, since the invention could equally be applied in conjunction with CD, DVD, or future optical disc standards, or even non-optical recording standards.

In FIG. 2 it is shown a dummy pattern 23, corresponding to a dummy channel word 20, which dummy pattern 23 can be modified into a modified dummy pattern 24, corresponding to a modified dummy channel word 22, according to a modification mask 21 defining a post-recording mark 25, where both the dummy channel word 20 and the modified channel word 22 are valid channel words. The dummy pattern 23 shown in the Figure is just an example and not the only one that can be used according to the invention. A pattern can be used as dummy pattern for the invention if there exists a modification masks such that the logical operation OR between the dummy pattern and the modification masks also correspond to a valid channel word; therefore there is also in principle no need for all dummy patterns to be equal.

According to a simple embodiment the record carrier can be provided with a number of dummy patterns, and for each dummy pattern one bit of information can be stored, by modifying or leaving unchanged the dummy pattern. If a dummy pattern can be modified by said post-recording into more than one valid modified dummy pattern, the location can hold more than just one bit of secondary information, allowing for a more compact coding of the secondary information.

The pattern shown in FIG. 2 can be used as a dummy pattern according to the invention, in a context where the 17PP modulation is employed, however it has to be said that it is in general not known a priori with which polarity a given channel word appears as pattern in the modulated bitstream, which is a non return to zero modulated bitstream (sometimes herein referred to as “NRZI bitstream”). In fact according to 17PP modulation, similarly to EFM and EFM+, it is foreseen that:

first, a channel word, i.e. a string of bits, is associated to a data word,

then, a pattern of pits and land is constructed upon the string of bits according to the following rule: a transition from pit to land or vice versa for a 1, no transition for a 0, the initial level, pit or land, being defined according to the previous word.

Therefore a given channel word may be represented with a given pattern or its opposite. It has to be reminded that with the known post-recording method it is only possible to convert ‘lands’ into ‘pits’. This uncertainty can be overcome by controlling the polarity of the generated modulated bitstream, for example by manipulating DC-control bit which are present before the sync pattern.

This need to control the polarity of the modulated bitstream can be overcome by using a dummy pattern which is corresponding to a channel word, and a modification mask, by which it is obtained, that whatever the polarity of the channel word, the modified dummy pattern that is obtained by applying the modification mask corresponds to a valid channel word. In this case it is correct to talk about dummy channel word.

A condition necessary but not sufficient to this end is that the recording mark 25 must extend over both pit and land of the dummy pattern: that is because whatever the polarity of the channel word a modification must occur, otherwise no information could be recorded.

This can be achieved for example if:

the modification mask defines a post-recording mark, which is superimposed to a transition from pit to land or vice versa in the dummy pattern, or

the modification mask defines two post-recording marks, which are superimposed one to a pit area and the other to a land area in the dummy pattern.

In alternative, the dummy pattern can be replaced by two dummy patterns, having opposite polarities to which the same modification mask is applied, so that at least one of the two dummy patterns is modified.

FIG. 3 shows an embodiment of a dummy pattern and a modification mask according to which the modification mask defines one post-recording mark, which is superimposed to a transition from pit to land or vice versa in the dummy pattern. In this example, the single post-recording mark, that is positioned over two 2 T run-lengths, T being one clock cycle of a reference clock or length unit, will convert the pre-recorded dummy channel word (with corresponding data byte value 75 h) into another valid channel word, with corresponding data byte values of either 25 h or 01 h, depending on the polarity of the dummy pattern. In one case (bit stream 1), a 2 T-2 T-2 T run-length sequence is converted into a 6 T run-length, in the other case (bit stream 2) a 2 T-2 T-3 T sequence is converted into a 7 T run-length.

In summary it is thus achieved that the polarity of the dummy pattern need not to be controlled because, regardless of its polarity, the valid channel word is modified into another valid channel word. A pattern can be used as dummy pattern for this embodiment of the invention if there exists a modification masks such that (dummy pattern OR modification masks) correspond to a valid channel word AND also (-dummy pattern OR modification masks), yet correspond to another valid channel word.

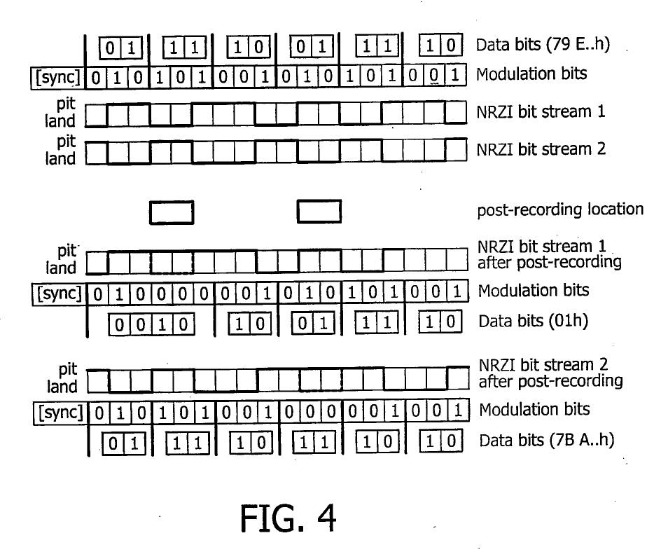

FIG. 4 shows an embodiment where the modification mask defines two post-recording marks, which are superimposed one to a pit area and the other to a land area in the dummy pattern. By this modification mask the pre-existing pattern (corresponding to the data word 79Eh) is modified into a modified dummy pattern corresponding data byte values of either 29Eh or 7BAh.

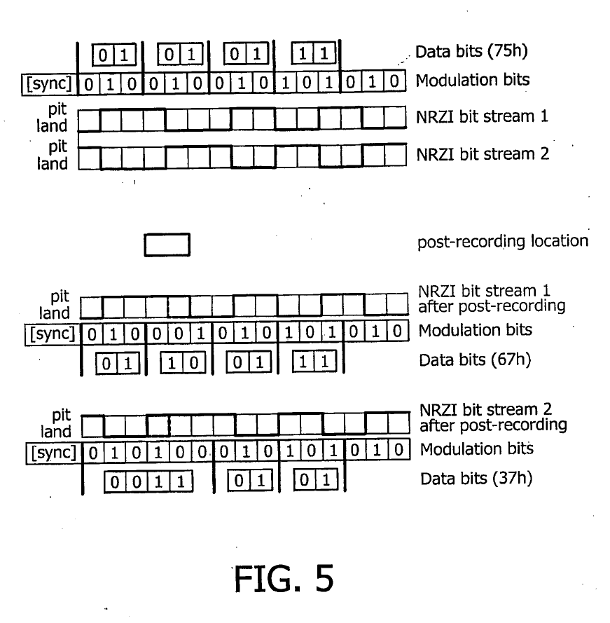

FIG. 5 shows an example where a single recorded mark, that is positioned partly over two 3 T run-lengths, will convert the pre-existing pattern (corresponding to the data byte 57 h) into a modified dummy pattern corresponding to data byte either 67 h or 37 h. In one case (bit stream 1), the 3 T-3 T run-lengths are converted into a 4 T-2 T sequence, in the other case (bit stream 2) into a 2 T-4 T sequence.

The solution proposed so far can still be improved regarding its robustness, that is in particular the ability to encompass errors of synchronization of the switching on and off of the laser for the post-recording mark.

In particular it can be noted that after post-recording, the modulation signal may have short run-lengths (2 T or 3 T) that are formed by the recorded mark in one of the following ways:

the recorded mark is a short run-length,

the land that is left just before or after the recorded mark is a short run-length, or

the recording of a mark results in a sequence of short run-lengths.

Short run-lengths are more vulnerable to detection errors than long run-lengths. As an example, referring to the graph shown in FIG. 4: overwriting of NRZI bit stream 1 at the right hand side with a 2 T mark upon an original 2 T pit requires a very well controlled mark length of the 2 T mark. In case it becomes too long, the original run-length gets affected.

It is also noted that he recorded mark length has to be accurately controlled.

The deviation between the actual mark length and the intended mark length has to be <<0.5 T, otherwise the probability increases that the detected run-length is 1 T longer or shorter than the intended run-length. This can lead to either invalid run-lengths (e.g. a 1 T run-length), or invalid modulation code words.

Therefore, according to preferred embodiments of the invention, the dummy patterns and the modification masks have at least one of the following additional properties to increase the detection robustness.

To avoid short run-lengths, a post-recording mark is placed on such a location and has such a nominal length (both defined by the modification mask) that, when falling on a pit will not influence the pit length, and when falling on a land will form together with the adjacent pits a long run-length that can be robustly detected. This is shown in FIG. 6B, a recorded mark in a 4 T pit will lead to a pit that is unaltered after recording and in FIG. 6A, a mark is recorded in a 4 T land that is adjacent to 2 T pits. After recording this is detected as an 8 T pit. Because an 8 T pit is fully modulated, small distortions on the detection signal on the transitions between prepressed pit and recorded mark do not lead to erroneously detected run-lengths.

To relax the need for accurate control of the switching on/off of the post-recording mark, the dummy pattern and the modification mask are defined so that the modified dummy patterns correspond to valid channel words even if the post-recorded mark has a deviation in length of one bit in the start stop of the post-recording mark, preferably regardless of the polarity.

In the example shown in, FIG. 7 it can be seen how short run-lengths are avoided. Before post-recording the 3 bytes have the value 334CC6 h. After post-recording with a 4 T mark on the locations indicated in the graph, the bytes have the values 334846 h or 214CC6 h, depending on the polarity of the modulated stream. In this case the dummy word is replaced by two (different) dummy words, having such polarities that adequate (different) modification masks will produce the modification of one of the two dummy words.

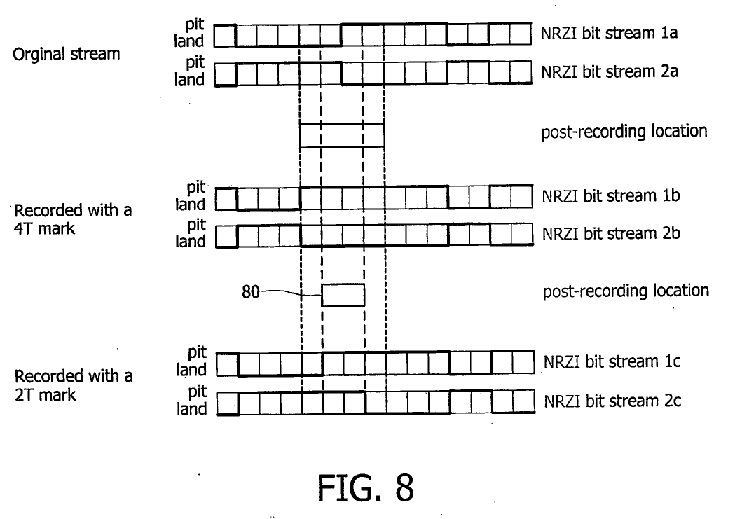

In the example shown in FIG. 8 it can be seen how the need for accurate control of the switching on/off of the post-recording mark can be relaxed. The original modulated bitstream is shown as stream 1a and stream 2a (of opposite polarity). If a 4 T mark is recorded, this will result in a −2 T or +2 T shift of a transition in the NRZI modulation stream, depending on the polarity of the modulated bitstream (see stream 1b and 2b). If due to a synchronization error, a 2 T mark is recorded instead, this will result in a −1 T or +1 T shift of a transition (see stream 1c and 2c). The original modulated bitstream can be constructed such that all bitstreams 1a/b/c and 2a/b/c are valid bitstreams. Because during decoding a run-length will be detected 1 T longer or shorter if the transition is shifted 0.5 T . . . 1.5 T, it is possible in this example to make valid bitstreams with recorded marks with a length of 1 T<mark length<5 T.

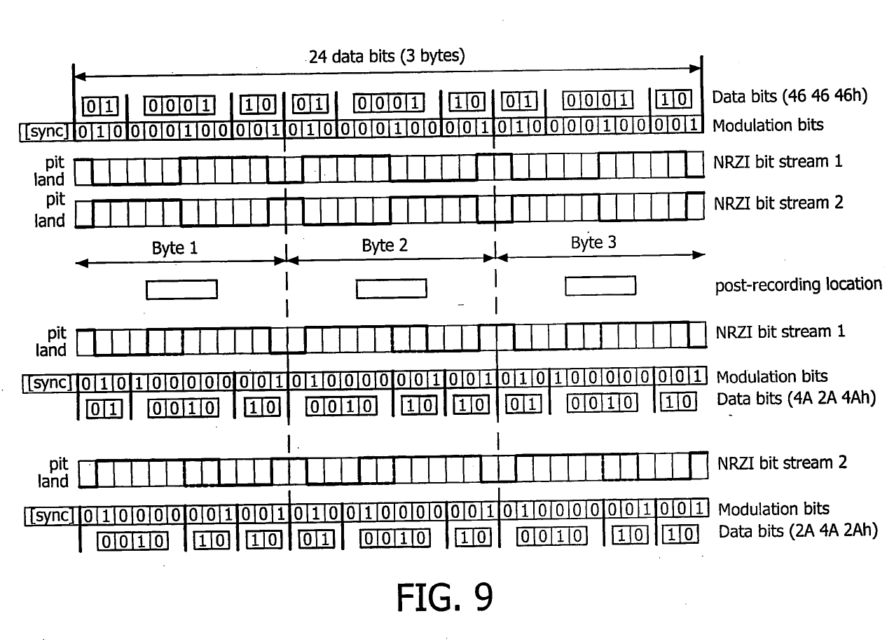

In FIG. 9 are shown three pre-recorded dummy patterns, all corresponding to the data-word 46h, which can be individually modified. After post-recording with a 4 T mark on the locations indicated in the Figure, a modified pattern corresponding to data words 2Ah or 4Ah can be created, depending on the polarity of the dummy pattern.

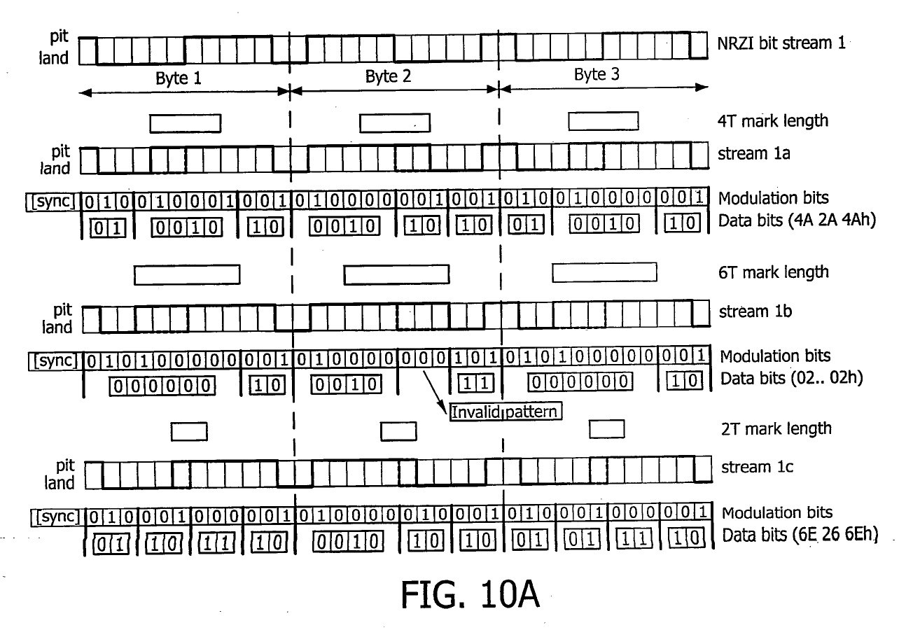

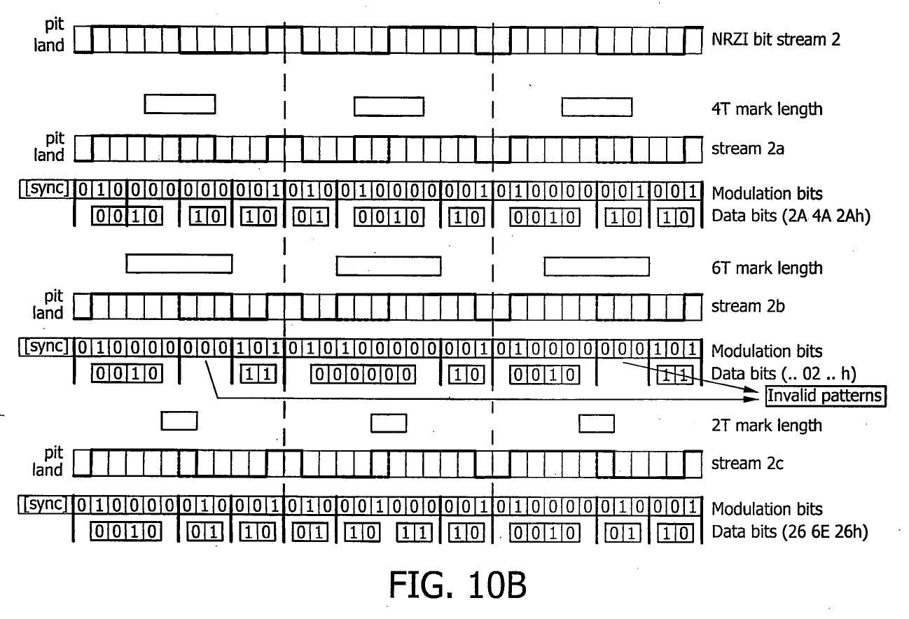

If stream 1 of FIG. 9 is post-recorded with a 2 T mark (shown in FIG. 10a), the data word 46h will be transformed into 26h or 6Eh, depending on the polarity of the modulated bitstream. Also shown in FIG. 10 is a post-recording with a 6 T post-recording mark. This results in data word 02h or an invalid pattern.

If stream 2 of FIG. 9 is post-recorded with a 2 T mark (shown in FIG. 10b), data word 46h will be transformed into 26h or 6Eh, depending on the polarity of the modulated bitstream. Again it is also shown with a 6 T post-recording mark. This results in data word 02h or an invalid pattern. Therefore, the use of a 6 T mark for post-recording on stream 2 of FIG. 9 should be avoided. If a 6 T recording occurs, then there is 50% chance that it can be decoded correctly (because there is 50% chance that the stream will be stream 1), so it can be regarded as an extra robustness. In case of stream 2, the output is unpredictable and depends on how the decoder handles violations against the 17PP rules. In that case the bit can be marked as ‘erasure’ and can possibly be corrected at a higher level (e.g. ECC over the secondary channel data bits.

With these embodiments a higher reliability of recording the data is achieved, because more tolerance of synchronization errors in start/stop of the recording mark is achieved.

FIG. 11 schematically shows an apparatus for reproducing secondary information from a modulated bitstream, where said the secondary information has been recorded with a method according to the invention. The modulated bitstream 10 is received by a demodulation unit 111 where it is converted into a succession of data words 112. This succession of data words 112 is fed to a decoding unit 113 which retrieves the content information 117. The decoding unit 113 may include various units for descrambling 114, deinterleaving 115 and for error correction 116, as these operation are typically involved in storage systems. A checking unit 118 checks the data words present at the positions corresponding to the predetermined positions in the modulated bitstream, where the dummy patterns are located.

Each of these data words is checked against its original value (value associated to the dummy pattern) or the value or values that may have the modified dummy pattern.

By establishing if a dummy pattern has been modified or not the secondary information 119 is retrieved. No error correction is applied while retrieving the secondary information, however: in the present invention channel bits are modified such that after decoding user data is modified. If the error correction unit was not disabled, the error correction unit would detect the modifications and correct them to the initial values, thus erasing the post-recorded data (if the error level does not exceed the capabilities of the error correction code).

The advantage of an apparatus according to the invention is that the demodulation unit 111 is the same as in a legacy apparatus because the channel words in the modulated bitstream are valid channel words.

In the Figure it is shown as an example that a data word is checked first against the value 75h (dummy channel word), and if not found to be equal to the value 75h it is then checked against the value 25h or 01h (dummy channel word modified, according to the polarity), thereby retrieving one bit of information, 0 for dummy channel word not modified or 1 for dummy channel word modified, or vice versa, whichever convention has been made in advance.

Briefly summarized, it is essential for an apparatus for reproducing secondary information that it:

identifies the positions in the succession of data words after demodulation, corresponding to the predetermined positions of the dummy patterns in the modulated bitstream, and

checks if the data words contained therein is the one corresponding to the dummy pattern, or to the modified dummy pattern, so as to reconstruct the secondary information.

Preferably, for instance in an application of the invention in a BD system, said predetermined positions are located after the frame sync of a recording frame and comprise a predetermined number of bits, in particular a number in the range from 1 to 5 bits. This makes it easy to detect and decode the post-recorded secondary information. The dummy channel words are preferably put in a lead-in area of the disc, so that no interference with the content information is created.

In the following section some comments as to interleaving of a Unique Disc ID channel words are given. A single error in the main channel, or a single write error, can corrupt two channel words (that usually are detected). By proper interleaving, these two errors are distributed over two codewords. This significantly helps in attaining a sufficiently high robustness.

Another advantage is that the method enforces that for each Unique Disc ID, the bit stream indicating this Unique Disc ID differs much from that indicating the absence of a Unique Disc ID. That is, it can reliably be detected if a disc contains a Unique Disc ID or not.

If a Unique Disc ID is to be added to the disc, parity bits according to a first error correcting code are preferably added to the bit stream representing this Unique Disc ID, resulting in a first encoded stream. The bits from this first stream are partitioned for example into groups of two bits, and to each of these groups, a parity bit is added. The resulting second bit stream is stored on disc by assigning to each bit a location on disc, and by recording the intended mark in this position only if its bit is a ‘1’.

Below two possible embodiments are given. It is proposed that in the Blu-ray Disc format 3 marks can be recorded immediately after each synchronization pattern. A shifted I2 on the boundary between two consecutive channel words will cause two consecutive errors, that often will be detected by the bit detection scheme. In order to cope with this situation, the 6=2×3 recording positions in 2 consecutive rows are partitioned into two sets, each containing 3 positions, none of them consecutive in a row, as indicated below (1^{st} embodiment).
Sync A B A
Sync B A B

The three bits in the positions indicated with ‘A’ are such that an odd number of them contains a ‘1’, and likewise an odd number of bits in the positions indicated with ‘B’ contain a ‘1’. If the detection algorithm judges two bits in the positions indicated by ‘A’ to be reliable, and the other bit as unreliable, the value of the unreliable bit can be computed from the fact that an odd number of these three bits is a ‘1’ (single erasure correction); so the two bits in the first encoded bit stream corresponding to the 3 bits in the positions indicated with ‘A’ are retrieved correctly, and the burden on the first error correcting code is reduced. Note that in the positions indicated by ‘A’, like in the positions indicated by ‘B’, either one or 3 recordings take place. So for each Unique Disc ID, in at least ⅓ of the potential recording positions, a recording indeed takes place. As a consequence, one can reliably distinguish between a disc without Unique Disc ID, and a disc on which a Unique Disc ID has been recorded.

According to a previous embodiment, a single write error (‘fat’ writing) can yield errors in the first and in the final bit in a row. Even when these two errors are detected, the first embodiment does not allow to correct them. In a second embodiment, 4 rows are used, 4 groups of 3 positions are chosen, all in different rows, and it is required that each group contains an odd number of 1's.

For example, the positions for the 4 groups A,B,C and D could be chosen as follows:
Sync A B C
Sync D A B
Sync C D A
Sync B C D

With this choice, the two errors resulting from a single error in the main channel or a single write error, are in different groups.

The reason to opt for 4 groups instead of 3 groups is that the error-correcting code in the first encoding step often is byte-based, i.e., it operates on groups of 8 bits. In summary, in this embodiment redundancy is introduced among recording events in order to make the retrieval of the recorded unique identifier even more robust. An additional advantage is that it enables to detect reliably if a disc contains a unique identifier or not.

The invention can be summarized as follows. The present invention relates to a method of recording secondary information on a record carrier, in particular on an optical record carrier, besides its content information, whereby it is possible to differentiate the record carrier from other record carrier bearing the same content information, for example by recording an individual identifier. The secondary information is recorded by forming at predetermined positions dummy patterns, preferably at the same moment as when recording the content information, and by recording the secondary information by selectively modifying the dummy patterns, thereby obtaining modified dummy patterns, wherein the dummy patterns as well as the modified dummy patterns correspond to valid channel words. The invention further relates to an apparatus for recording secondary information, to a record carrier, and to a method and to an apparatus for reproducing the secondary information.

1. A method of recording secondary information on an optical record carrier for comprising content information encoded as a sequence of channel words corresponding to patterns of pits and lands, the method comprising:
forming at predetermined positions dummy patterns (23),
recording the secondary information by selectively modifying the dummy patterns, thereby obtaining modified dummy patterns (24),
characterized in that
the dummy patterns as well as the modified dummy patterns correspond to valid channel words.

2. A method as claimed in claim 1, characterized in that modifying a dummy pattern (23) is obtained according to a modification mask (21) extending over the dummy pattern, whereby the modified dummy pattern (24) is obtained as the result of the logical operation OR between the dummy pattern and the modification mask, the dummy pattern and the modified dummy pattern being represented by the value 1 in correspondence to a pit and 0 elsewhere, the modification mask being represented by the value 1 in correspondence to a point to be modified and 0 elsewhere.

3. A method as claimed in claim 1, characterized in that modifying the dummy pattern (23) is effected by applying a laser ablation to the dummy pattern, whereby pits (10, 12) remain pits and that lands (11) are modified into pits (14, 15).

4. A method as claimed in claim 2, characterized in that the modification mask (21) and the dummy pattern (23) have the property that the pattern obtainable as the result of the logical operation OR between the negative of the dummy pattern (30) and the modification mask also corresponds to a valid channel word.

5. A method as claimed in claim 1, characterized in that the patterns have a finite length corresponding to n length units, the pits and the lands extending over one or more length units.

6. A method as claimed in claim 2, characterized in that the modification mask (21) defines a post-recording mark (25) starting on a first position and ending on a second position, and the modification mask and the dummy pattern (23) have the property that the pattern obtainable as the result of the logical operation OR between the dummy pattern and the modification mask where the first position and/or the second position is shifted of one length unit (80) also corresponds to a valid channel word.

7. A method as claimed in claim 6, characterized in that the modification mask (21) and the dummy pattern (23) further have the property that the pattern obtainable as the result of the logical operation OR between the negative of the dummy pattern and the modification mask where the first position and/or the second position is shifted of one length unit also corresponds to a valid channel word.

8. A method as claimed in claim 1, characterized in that recording the secondary information is effected by:
encoding the secondary information into a succession of binary values, and
modifying a dummy pattern (23) for storing a 1 of the succession of binary values, or
not modifying the dummy pattern for storing a 0 of the succession of binary values, or vice versa.

9. A method as claimed in claim 1, comprising a step of prerecording content information, and the prerecording of content information and the forming of the dummy patterns (23) at the predetermined positions are obtained by a molding process.

10. A method for producing a plurality of information carriers bearing a common content information, comprising:
recording the common content information and secondary information with a method as claimed in claim 9, where the step or recording secondary information comprises the recording of an individual code.

11. An apparatus for recording secondary information on an optical record carrier for comprising content information encoded as a sequence of channel words corresponding to patterns of pits and lands, the apparatus comprising:
a recording unit for forming at predetermined positions dummy patterns (23),
a post-recording unit for recording the secondary information by selectively modifying the dummy patterns, thereby obtaining modified dummy patterns (24), characterized in that
the dummy patterns as well as the modified dummy patterns correspond to valid channel words.

12. An apparatus for recording secondary information on an optical record carrier for comprising content information encoded as a sequence of channel words corresponding to patterns of pits and lands, the information carrier comprising at predetermined positions dummy patterns (23), the apparatus comprising:
a post-recording unit for recording the secondary information by selectively modifying the dummy patterns, thereby obtaining modified dummy patterns (24), characterized in that
the dummy patterns as well as the modified dummy patterns correspond to valid channel words.

13. An apparatus as claimed in claim 11, characterized in that the post-recording unit is adapted for modifying the dummy patterns (23) according to a modification mask (21).

14. An apparatus as claimed in claim 11, characterized in that the post-recording unit is adapted for modifying the dummy patterns (23) by applying a laser ablation to the patterns, whereby pits (10, 12) remain pits and that lands (11) are modified into pits (14, 15).

15. An apparatus as claimed in claim 11, characterized in that the post-recording unit is adapted for recording the secondary information by:
encoding the secondary information into a secondary stream of binary values, and
modifying a dummy pattern (23) for storing a 1 of the secondary stream or not modifying a dummy pattern for storing a 0 of the secondary stream, or vice versa.

16. An apparatus as claimed in claim 11, further comprising a prerecording unit for prerecording the content information, wherein said prerecording of the content information and the forming of the dummy patterns (23) at the predetermined positions are obtained by a molding process.

17. A record carrier for comprising content information encoded as a sequence of channel words corresponding to patterns of pits and lands, the record carrier comprising a predetermined positions dummy patterns (23) for being selectively modified thereby encoding secondary information, characterized in that the dummy patterns correspond to valid channel words.

18. A record carrier for comprising content information encoded as a sequence of channel words corresponding to patterns of pits and lands, the record carrier comprising a predetermined positions either dummy patterns (23) or modified dummy patterns (24), thereby encoding secondary information, characterized in that the dummy patterns as well as the modified dummy patterns correspond to valid channel words.

19. A recording system for recording of secondary information on a record carrier, comprising:
a recording apparatus as claimed in claim 12, and
the record carrier comprising content information encoded as a sequence of channel words corresponding to patterns of pits and lands, the record carrier comprising a predetermined positions dummy patterns (23) for being selectively modified thereby encoding secondary information, characterized in that the dummy patterns correspond to valid channel words.

20. A method of reproducing secondary information (119) recorded on an record carrier for comprising content information (117) encoded as a sequence of channel words corresponding to patterns of pits and lands, the record carrier comprising a predetermined positions either dummy patterns (23) or modified dummy patterns (24), thereby encoding the secondary information, the method comprising:
checking at the predetermined positions whether a dummy pattern or a modified dummy pattern is present, thereby retrieving the secondary information, characterized in that
the dummy patterns as well as the modified dummy patterns correspond to valid channel words.

21. An apparatus for reproducing secondary information (119) recorded on an record carrier for comprising content information (117) encoded as a sequence of channel words corresponding to patterns of pits and lands, the record carrier comprising a predetermined positions either dummy patterns (23) or modified dummy patterns (24), thereby encoding the secondary information, the apparatus comprising:
a check unit (118) for checking at the predetermined positions whether a dummy pattern or a modified dummy pattern is present, thereby retrieving the secondary information, characterized in that
the dummy patterns as well as the modified dummy patterns correspond to valid channel words.
